(19) United States
(12) Patent Application Publication
(10) Pub. No.: US 2016/0334161 A1
(43) Pub. Date: Nov. 17, 2016

(54) CONTAINER FOR DRYING THREE-DIMENSIONAL PRINTED OBJECTS

(71) Applicants: Joseph R. Gutzman, St. Paul, MN (US); Jon D. Erickson, St. Paul, MN (US)

(72) Inventors: Joseph R. Gutzman, St. Paul, MN (US); Jon D. Erickson, St. Paul, MN (US)

(21) Appl. No.: 15/148,597

(22) Filed: May 6, 2016

Related U.S. Application Data
(60) Provisional application No. 62/179,655, filed on May 15, 2015.

(51) Int. Cl. F26B 9/06; B33Y 40/00; F26B 25/00; F26B 3/04; F26B 21/00

(52) U.S. Cl. CPC F26B 9/06; F26B 3/04; F26B 21/001; F26B 25/003; B33Y 40/00

(57) ABSTRACT

A post rapid prototyping device for drying a three dimensional printed object using forced air from an air blower, the device includes a housing having a substantially slanted bottom element and a drain, a top having a door for access to the interior of said housing wherein a drying hook is attached to the door, the housing has an aperture in a side element operable to receive air from the air blower and a vertical air channel operable to receive the forced air from said aperture, such that an output end of said vertical air channel focusses the air to a first drying location on said inside surface of said bottom element.

### PRIORITY CLAIM

This application claims priority to U.S. Provisional Patent Application Ser. No. 62/179,655 entitled “A container for drying three-dimensional printed objects” filed May 15, 2015, the contents of which are incorporated herein by reference.

### FIELD OF THE INVENTION

This invention relates to dryers, and more particularly to a device for drying a surface of a three-dimensional printed object.

### BACKGROUND OF THE INVENTION

Three dimensional printing is becoming increasingly commonplace. Components that have been created using three dimensional printers generally require drying for prolonged periods. A variety of compartments have been developed that are especially designed for receiving an air flow and for containing articles to be dried. These devices include compartments for drying objects such as clothing and towels. However, none of these devices is will suited to three dimensional printed objects.

### SUMMARY OF THE INVENTION

The invention includes a container for drying three dimensional printed objects by way of forcing heated air to circulate over and around the objects to be dried. The invention includes a round or oblong plastic or metal drying container. The container will reduce the drying time for three dimensional printed objects after removal of the objects from their detergent bath by having air heated from an external source connected to the container circulate through the container. The objects to be dried will be hung from a drying hook attached to the removable cover of the container or will be placed on a grate within the container. The container will have an entry port or ports to allow heated air from an external source direct access to the interior of the container and will have an exhaust port or ports to allow air to exit the container. The container has a sloped bottom or lower drip plate to collect any liquids draining from the objects to be dried and has a spigot or exit hole at the bottom to allow such liquid to exit the container.

In one embodiment, the invention includes a post rapid prototyping device for drying a three dimensional printed object using forced air from an air blower. The device includes a housing having a substantially slanted bottom element including a drain, a top having a door for access to the interior of said housing, wherein a drying hook is attached to the door, the housing having an aperture in a side element operable to receive air from the air blower, and a vertical air channel operable to receive the forced air from said aperture, such that an output end of said vertical air channel focusses the air to a first drying location on said inside surface of said bottom element. At least one horizontal air channel having a first end that joins said vertical air channel, said horizontal air channel being substantially perpendicular to said vertical air channel such that an output end of said horizontal air channel focusses said air to a second drying location on the inside surface of said door.

In an alternate embodiment, the invention includes a dryer box for drying a surface of a three-dimensional printed article, using forced air from an air blower. The invention includes a housing having a substantially circular shape, and having a substantially slanted bottom element, and having a top with a door for access to the interior of said housing, and having an aperture in a wall operable to receive the forced air from the air blower. A first air channel operable to receive air from said aperture and extending downwardly from said aperture to a point above the inside surface of said bottom element, such that an output end of said first air channel focusses the air to a first drying location on said inside surface of said bottom element. A second air channel having a first end that joins said first air channel, said second air channel having an output end that focusses said air to a second drying location on the inside surface of said door; and means for attaching a three dimensional article to the inside surface of said door proximate to said second end of said second air channel.

### BRIEF DESCRIPTION OF THE DRAWINGS

The invention may be more completely understood in consideration of the following detailed description of various embodiments of the invention in connection with the accompanying drawings, in which:

FIG. 1 shows an isometric view of the container in accordance with the invention.

FIG. 2 shows a side view of the container in accordance with the invention.

FIG. 3 shows a front view of the container in accordance with the invention.

FIG. 4 shows a top view of the container in accordance with the invention.

FIG. 5 shows an exploded view of the container in accordance with the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENT

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

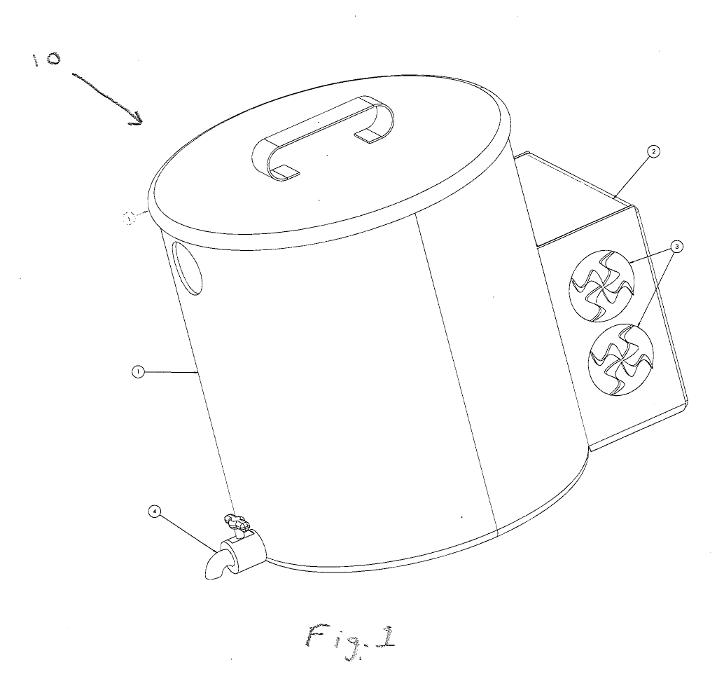

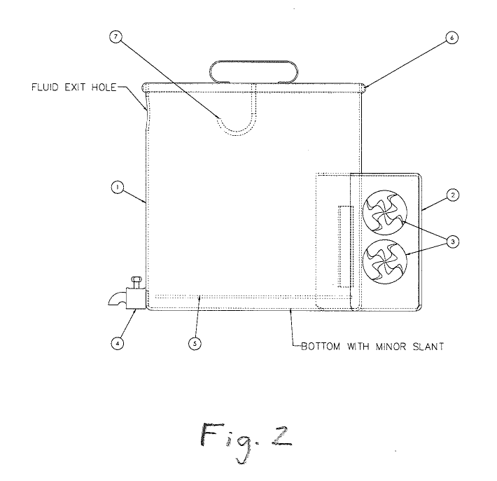

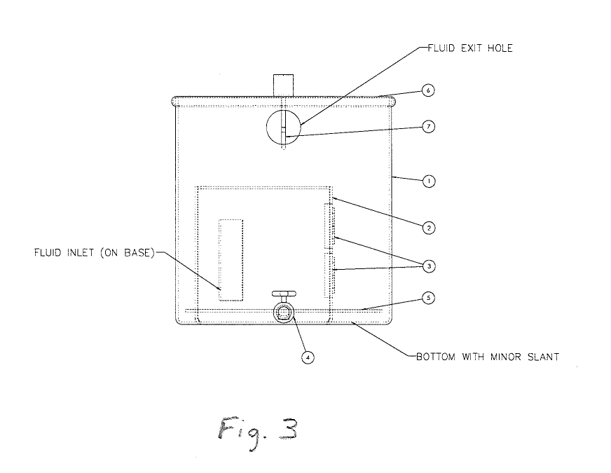

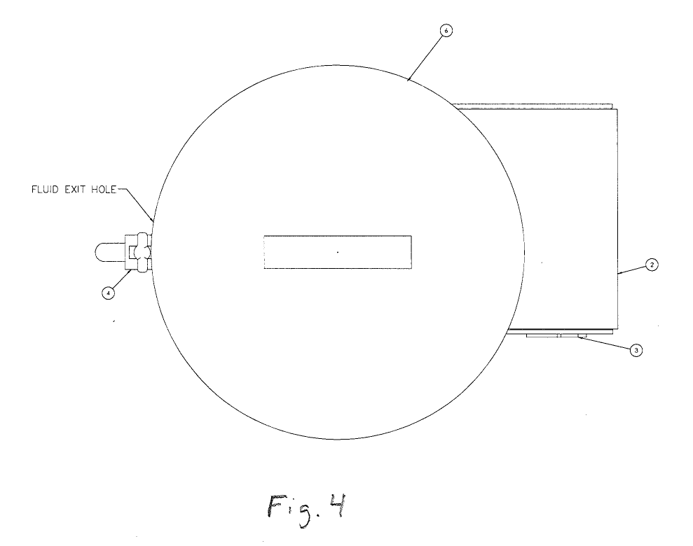

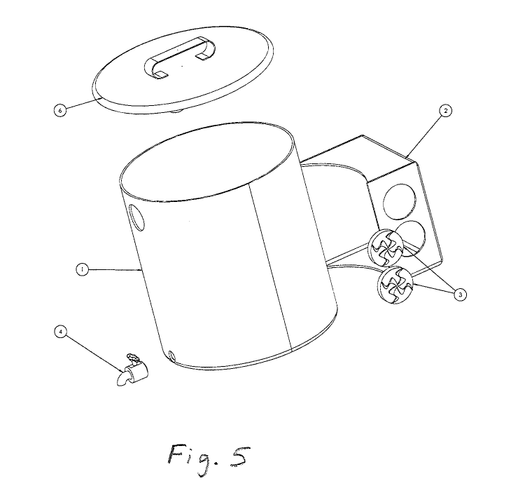

With reference to FIGS. 1-5, the details of the invention will now be discussed. A container 10 for drying three dimensional printed objects by way of forcing heated air to circulate over and around the objects to be dried is shown in FIG. 1. The generally round or oblong plastic or metal drying container 10 will reduce the drying time for three dimensional printed objects after removal of the objects from their detergent bath by having air heated from an external source connected to the container circulate through the container. As shown in FIG. 1, the container is includes a base 1. An external source is disposed in the wall of the base that includes one or more heating elements 3. With reference to FIG. 2, the objects to be dried will be hung from a drying hook 7 attached to the removable cover 6 of the container 10 or will be placed on a grate 5 within the container. The hook 7 is generally curved to suspend an object from the cover 6. The container 10 will have an entry port 2 or ports to allow heated air from an external source direct access to the interior of the container and will have an exhaust port or ports to allow air to exit the container. In a preferred embodiment, the container 10 will have a sloped bottom or lower drip plate to collect any liquids draining from the objects to be dried and will have a spigot 4 or exit hole at the bottom to allow such liquid to exit the container. In one embodiment, spigot 4 is an aperture formed in the wall of base 1. In another involvement, container 10 spigot 4 is configured to control the flow of fluid in and out of container 10.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A post rapid prototyping device for drying a three dimensional printed object using forced air from an air blower, the device comprising:
a. a housing having a substantially slanted bottom element including a drain,
b. a top having a door for access to the interior of said housing, wherein a drying hook is attached to the door, the housing having an aperture in a side element operable to receive air from the air blower;
c. a vertical air channel operable to receive the forced air from said aperture, such that an output end of said vertical air channel focusses the air to a first drying location on said inside surface of said bottom element;
d. at least one horizontal air channel having a first end that joins said vertical air channel, said horizontal air channel being substantially perpendicular to said vertical air channel such that an output end of said horizontal air channel focusses said air to a second drying location on the inside surface of said door.

2. The dryer box of claim 1, wherein said housing is substantially circular in shape.

3. The dryer box of claim 1, wherein said housing is substantially made from a plastic laminate.

4. The dryer box of claim 1, wherein the air blower is a dryer gun, and further comprising a sleeve extending from said housing for receiving the dryer.

5. The dryer box of claim 1, wherein said top is hinged to the housing.

6. The dryer box of claim 1, wherein said door operates by means of a hinge.

7. The dryer box of claim 10, wherein said hinge is at the side of said door.

8. A dryer box for drying a surface of a three dimensional printed article, using forced air from an air blower, comprising:
a housing having a substantially circular shape, and having a substantially slanted bottom element, and having a top with a door for access to the interior of said housing, and having an aperture in a wall operable to receive the forced air from the air blower, wherein said wall is a side wall;
a first air channel operable to receive air from said aperture and extending downwardly from said aperture to a point above the inside surface of said bottom element, such that an output end of said first air channel focusses the air to a first drying location on said inside surface of said bottom element;
a second air channel having a first end that joins said first air channel, said second air channel having an output end that focusses said air to a second drying location on the inside surface of said door; and
means for attaching a three dimensional article to the inside surface of said door proximate to said second end of said second air channel.

9. The dryer box of claim 8, wherein said first air channel and said second air channel are perpendicular such that said second air channel focusses air toward a vertical side wall of said housing.

10. The dryer box of claim 8, wherein said first air channel and said second air channel are in line such that said second air channel focuses air toward the top of said housing.

11. The dryer box of claim 8, wherein said housing is substantially made from a plastic laminate.

12. The dryer box of claim 8, further comprising a sleeve extending from said housing for receiving a dryer gun.

13. The dryer box of claim 8, wherein said door is formed by hinging said wall.

14. The dryer box of claim 8, wherein said box has a third air channel and a second door for providing a third drying location.
